(19) United States
(12) Patent Application Publication
(10) Pub. No.: US 2026/0324662 A1
(43) Pub. Date: Oct. 22, 2026

(54) SYSTEM AND METHOD FOR PRODUCING SOFT-BOILED EGGS

(71) Applicant: J & J Real Estate Investment Fund LLC, San Jose, CA (US)

(72) Inventor: George Chen, San Jose, CA (US)

(21) Appl. No.: 19/654,089

(22) Filed: Apr. 21, 2026

Related U.S. Application Data
(60) Provisional application No. 63/792,509, filed on Apr. 22, 2025.

(51) Int. Cl. A23B 5/10; A23B 2/30; A23B 2/53; A23B 2/721; A23B 5/005; A23L 5/10; A23L 15/00

(52) U.S. Cl. CPC A23B 5/10; A23B 2/30; A23B 2/53; A23B 2/721; A23B 5/0052; A23L 5/13; A23L 15/00

(57) ABSTRACT

A method of producing soft-boiled eggs in a soft-boiled eggs production system includes subjecting eggs to a drying chamber, to induce aging and increase internal pH; conveying eggs having dimensional or weight variations along a processing path; contacting the eggs with a rotating paddle assembly; wherein the rotating paddle assembly: reorients a single egg into a stable position by one of a plurality of spoon-shaped member; and releases the eggs; allowing the eggs to drop under gravity and impact a metal bar to induce controlled cracking of the eggshell; boiling the eggs under conditions sufficient to produce the soft-boiled interior; and cooling the eggs in a cooling tank to stabilize the internal structure; treating the eggs with ozone-treated water to reduce microbial contamination; removing eggshells from the eggs; sterilizing the eggs using ultraviolet (UV) light prior to packaging; vacuum-packaging the eggs; vacuum-heating the vacuum-packaged eggs.

### FIELD OF THE DISCLOSURE

The present disclosure generally relates to food processing systems and methods. More particularly, the present disclosure relates to systems and methods for processing eggs, and in particular to systems and methods for producing soft-boiled eggs with improved peeling efficiency, structural integrity, and microbial safety.

### BACKGROUND OF THE DISCLOSURE

Eggs are widely consumed as a nutritious food product and are commonly prepared in various forms, including soft-boiled eggs. In commercial production environments, processing eggs into soft-boiled products presents several technical challenges. For example, conventional methods often result in inconsistent cooking, difficulty in peeling, and damage to the egg white during shell removal.

In particular, adhesion between the eggshell membrane and the egg white can make peeling difficult, especially for soft-boiled eggs where the internal structure remains delicate. Existing approaches to improve peelability, such as prolonged storage or chemical treatment, may negatively affect product quality, safety, or processing efficiency.

Furthermore, conventional egg processing systems typically lack precise control over cracking of the eggshell prior to cooking. Manual or uncontrolled cracking can lead to fragmentation of the shell and damage to the internal contents, resulting in reduced yield and inconsistent product quality. Additionally, variations in egg size and weight may lead to uneven heat transfer during cooking, thereby affecting the consistency of the soft-boiled interior.

Microbial contamination is another concern in egg processing. Traditional sterilization techniques may be insufficient or may adversely affect the texture and quality of the eggs. Moreover, the sequence and integration of processing steps—such as cracking, cooking, cooling, sterilization, and packaging—are often not optimized to achieve both high product quality and food safety.

Accordingly, there is a need for improved egg processing systems and methods that address one or more of the above-mentioned issues. In particular, there is a need for systems and methods that enable controlled cracking of eggshells, enhance peeling efficiency, provide consistent cooking results, and improve microbial safety while maintaining the structural integrity and quality of soft-boiled eggs.

The disclosed embodiments may seek to satisfy one or more of the above-mentioned desires. Although the present embodiments may obviate one or more of the above-mentioned desires, it should be understood that some aspects of the embodiments might not necessarily obviate them.

### BRIEF SUMMARY OF THE DISCLOSURE

In a general implementation, a method of producing soft-boiled eggs in a soft-boiled eggs production system may comprise subjecting eggs to a drying chamber of the soft-boiled eggs production system, to induce aging and increase internal pH; conveying eggs having dimensional or weight variations along a processing path; contacting the eggs with a rotating paddle assembly of the soft-boiled eggs production system; wherein the rotating paddle assembly: reorients a single egg into a stable position by one of a plurality of spoon-shaped member of the soft-boiled eggs production system; and releases the eggs; allowing the eggs to drop under gravity and impact a metal bar of the soft-boiled eggs production system to induce controlled cracking of the eggshell; boiling the eggs under conditions sufficient to produce the soft-boiled interior; and cooling the eggs in a cooling tank of the soft-boiled eggs production system to stabilize the internal structure; removing eggshells from the eggs while applying ozone to the eggs; sterilizing the eggs using ultraviolet (UV) light of a soft-boiled eggs production system prior to packaging; vacuum-packaging the eggs; vacuum-heating the vacuum-packaged eggs after UV sterilization to further stabilize the eggs and reduce microbial contamination; wherein the method improves peeling efficiency while maintaining structural integrity of the eggs.

In another aspect combinable with the general implementation, the plurality of spoon-shaped members is rotatable to receive and reorient the eggs in the stable position, guide the egg along a downward path, and release the egg to drop under gravity.

Further, it is contemplated that conveying eggs comprises using partition members and rollers of the soft-boiled eggs production system to guide the eggs toward the rotating paddle assembly.

In the alternative, the metal bar is vertically adjustable to vary a controlled distance between the rotating paddle assembly and the metal bar and the cracking of the eggshell is controlled by adjusting the controlled distance between the rotating paddle assembly and the metal bar to vary an impact force applied to the eggs.

In another aspect combinable with the general implementation, the controlled distance between the rotating paddle assembly and the metal bar is selected to control an impact force applied to the eggs, the controlled distance being between 5 mm and 50 mm to achieve controlled cracking of the eggshell without causing fragmentation.

In another aspect combinable with the general implementation, each egg is individually supported by the spoon-shaped member of the rotating paddle assembly.

In another aspect combinable with the general implementation, each egg is placed in the drying chamber for a duration of 4-8 hours to increase internal pH and promote separation between the eggshell membrane and egg white.

In another aspect combinable with the general implementation, the eggs are pre-selected to have a weight variation within ±2 grams to promote uniform heat transfer during cooking.

In another aspect combinable with the general implementation, the cooling tank is maintained at a temperature above 0 °C and below 1 °C to prevent freezing of the eggs.

In another aspect combinable with the general implementation, boiling the eggs comprises heating the eggs at about 80 °C for about 20 minutes to produce a soft-boiled interior, the eggs having been previously subjected to the drying process and controlled cracking.

In another aspect combinable with the general implementation, the method may further comprise applying ozone to the eggs during removal of the eggshell; and

subsequently treating the eggs with ozone-treated water and ultraviolet (UV) light after cooling.

In another aspect combinable with the general implementation, the rotating paddle assembly is intermittently rotated with pauses between rotations to allow individual eggs to be released one at a time.

In another aspect combinable with the general implementation, the internal pH of the eggs is increased to between 9 and 10 to reduce adhesion between an eggshell membrane and egg white and facilitate removal of the eggshell.

In another aspect combinable with the general implementation, vacuum-heating the vacuum-packaged eggs comprises heating the eggs at a temperature of 60-90 °C to stabilize internal structure while reducing microbial contamination without overcooking the eggs.

Another aspect of the embodiment is directed to a soft-boiled eggs production system comprising:
a plurality of rollers and partition members configured to transport and separate eggs along a processing path;
a rotating paddle assembly comprising a rotatable shaft and a plurality of spoon-shaped members mounted on the shaft, each spoon-shaped member configured to receive and support a single egg;
wherein the rotating paddle assembly is configured such that eggs are released from the spoon-shaped members under gravity at a lower portion of the rotating paddle assembly;
a metal bar positioned below the rotating paddle assembly to receive eggs released from the rotating paddle assembly;
wherein the metal bar is vertically adjustable relative to the rotating paddle assembly to vary a controlled distance therebetween and to control an impact force applied to the eggs to induce controlled cracking of eggshells without causing fragmentation;
a heating apparatus configured to cook the eggs to produce a soft-boiled interior;
a cooling tank configured to cool the eggs;
a treatment station configured to expose the eggs to ozone-treated water and ultraviolet light; and
a packaging apparatus configured to vacuum-package and heat the eggs.

It is still further contemplated that a controlled distance between the rotating paddle assembly and the metal bar is between 5 mm and 50 mm to control the impact force applied to the eggs.

In another aspect combinable with the general implementation, the rotating paddle assembly is configured to intermittently rotate to release eggs one at a time.

In another aspect combinable with the general implementation, the system may further comprise a drying chamber configured to maintain eggs for a duration of 4-8 hours to increase internal pH to between 9 and 10.

In another aspect combinable with the general implementation, the cooling tank is configured to maintain a temperature above 0 °C and below 1 °C.

In another aspect combinable with the general implementation, the packaging apparatus includes a vacuum chamber and a heater configured to heat vacuum-packaged eggs at a temperature of 60-90 °C.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above and below as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, operations, methods, or processes described herein may include more steps or fewer steps than those described. Further, the steps in such example operations, methods, or processes may be performed in different successions than those described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be on a precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a schematic diagram illustrating a first portion of a method for producing soft-boiled eggs, including pre-conditioning, conveying, and positioning of eggs in a rotating paddle assembly.

FIG. 2 is a schematic diagram illustrating a second portion of the method of FIG. 1, including dropping of eggs, controlled cracking, cooking, cooling, and post-processing steps.

FIG. 3 is a schematic diagram illustrating a third portion of the method of FIG. 1, including treating, sterilizing, and packaging the eggs.

FIG. 4 is a schematic diagram illustrating a rotating paddle assembly including a plurality of spoon-shaped members configured to receive, support, and reorient eggs.

FIG. 5 is a perspective view of a soft-boiled egg production system according to an aspect of the embodiments.

FIG. 6 is an enlarged view illustrating a conveying assembly including rollers and partition members configured to transport and separate eggs along a processing path.

FIG. 7A is an enlarged view showing eggs being transported through the conveying assembly in accordance with an aspect of the embodiments.

FIG. 7B is an enlarged view showing the eggs contacting with a rotating paddle assembly of the soft-boiled eggs production system in accordance with an aspect of the embodiments.

FIG. 8 is a perspective view illustrating a metal bar positioned below the rotating paddle assembly to allow the eggs to drop under gravity and impact the metal bar to induce controlled cracking of the eggshell.

FIG. 9 is a block diagram showing a soft-boiled egg production system according to an aspect of the embodiments.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

Unless defined otherwise, all technical and position terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

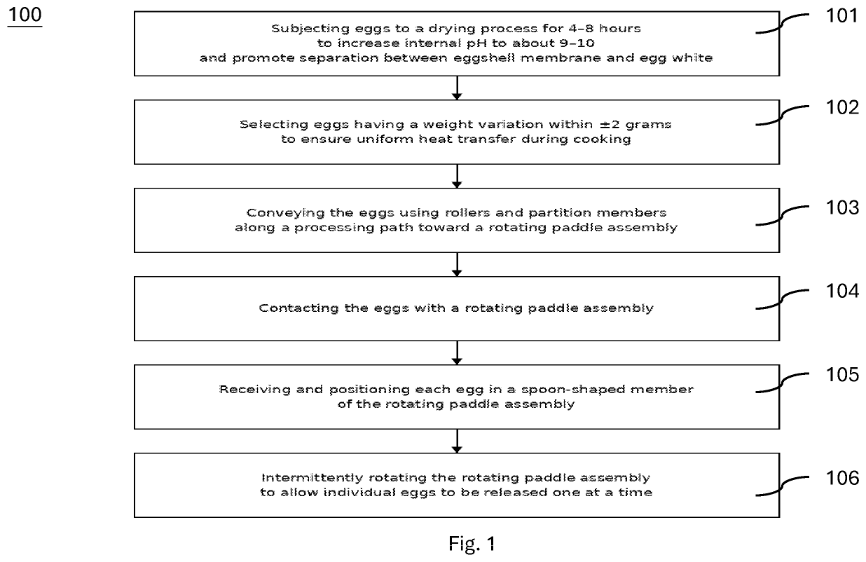

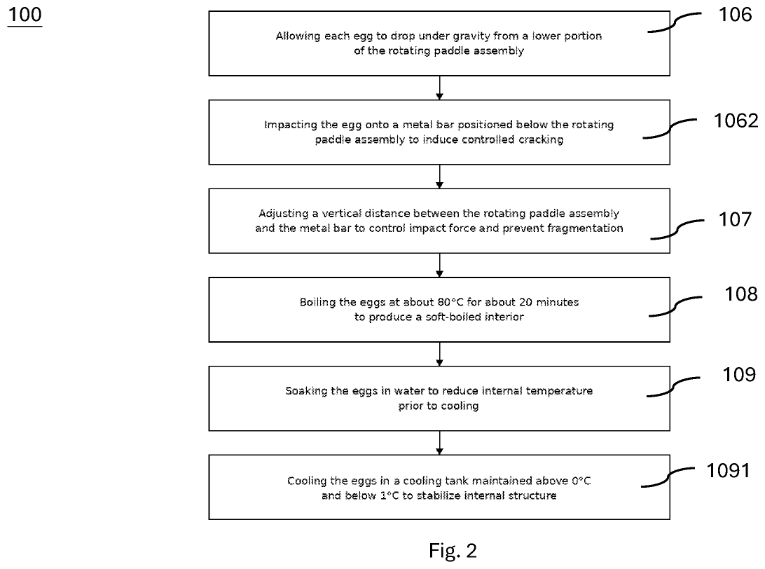

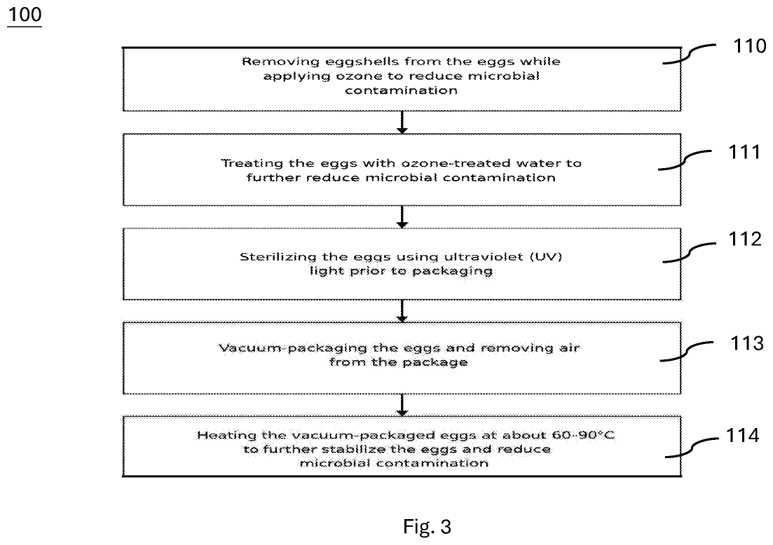

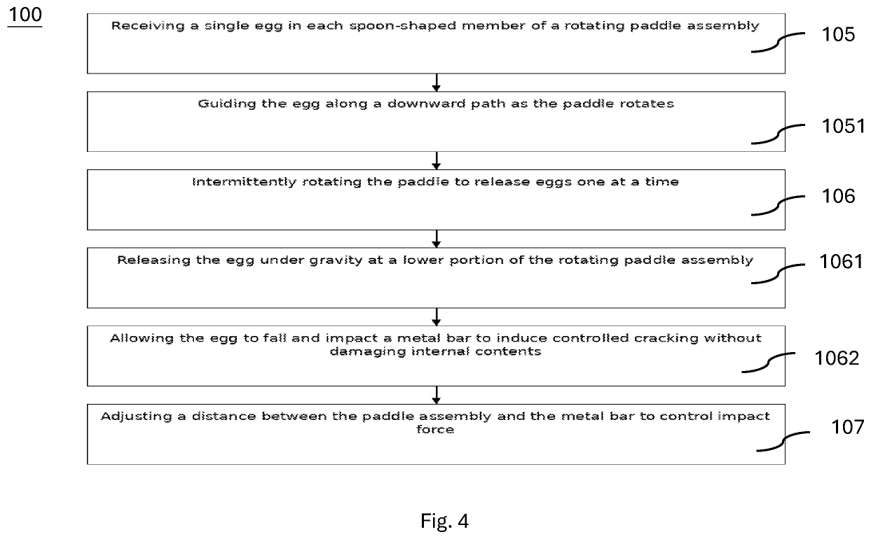

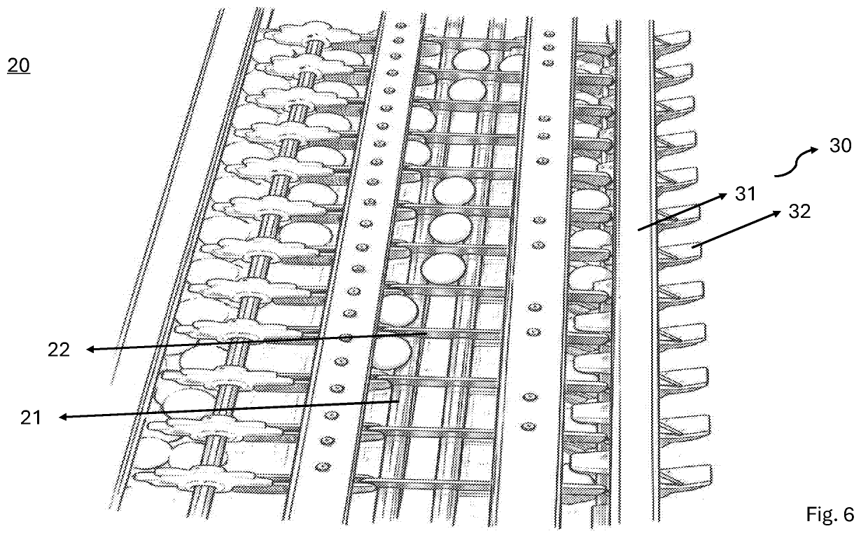

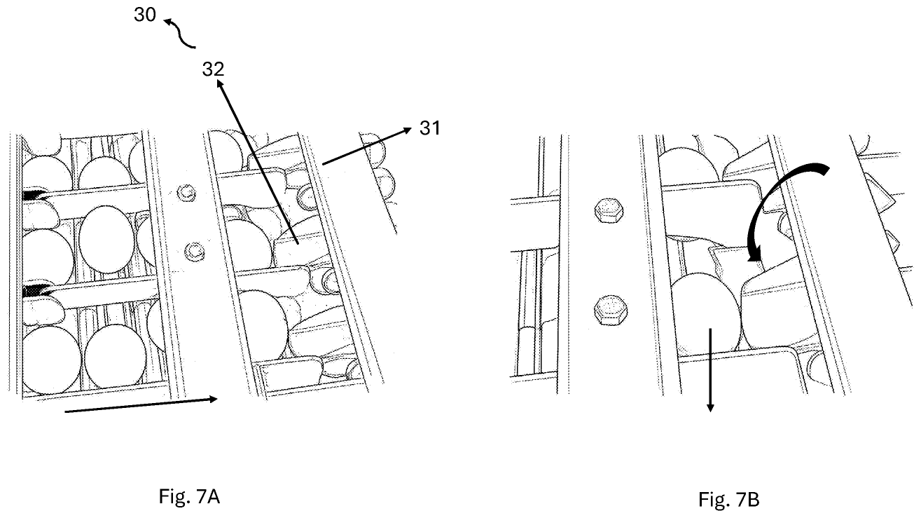

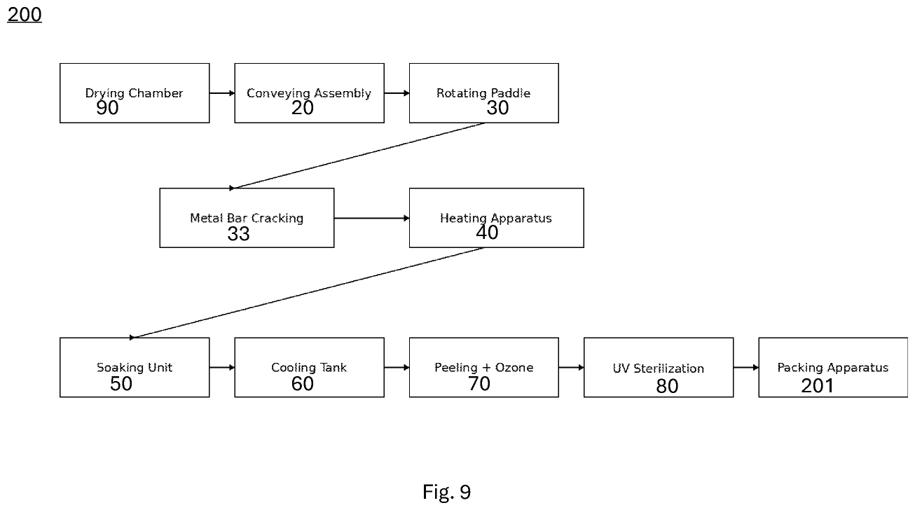

FIGS. 1-9 generally depicts a method of producing soft-boiled eggs in a soft-boiled egg production system 100 and the soft-boiled egg production system 200 according to an aspect of the embodiments.

Referring to FIG. 1 to FIG. 4, in some embodiments, a method of producing soft-boiled eggs 100 may comprise steps of:
subjecting eggs to a drying chamber of the soft-boiled eggs production system to induce aging and increase internal pH 101;
conveying eggs having dimensional or weight variations along a processing path 103;
contacting the eggs with a rotating paddle assembly of the soft-boiled eggs production system 104;
wherein the rotating paddle assembly:
reorients a single egg into a stable position by one of a plurality of spoon-shaped members of the soft-boiled eggs production system 104; and
releases the eggs 106;
allowing the eggs to drop under gravity and impact a metal bar of the soft-boiled eggs production system to induce controlled cracking of the eggshell 1061, 1062;
boiling the eggs under conditions sufficient to produce a soft-boiled interior 108; and
cooling the eggs in a cooling tank to stabilize the internal structure 1091;
treating the eggs with ozone-treated water to reduce microbial contamination 110;
removing eggshells from the eggs while applying ozone to the eggs 110;
treating the eggs with ozone-treated water to further reduce microbial contamination after the removal of eggshells to further reduce microbial contamination of exposed egg surface 111;
sterilizing the eggs using ultraviolet (UV) light of the soft-boiled eggs production system prior to packaging 112;
vacuum-packaging the eggs 113;
vacuum-heating the vacuum-packaged eggs at a temperature of 60-90 °C to further stabilize the eggs and reduce microbial contamination 114.
wherein the method improves peeling efficiency while maintaining structural integrity of the eggs.

It should be noted that, in some embodiments, the present method uniquely enables controlled cracking of eggshells prior to cooking, thereby facilitating peeling of soft-boiled eggs without compromising internal egg structure.

Continuing to FIG. 1, the steps of subjecting eggs to a drying process may be performed in a drying chamber, wherein the drying chamber may be controlled with respect to temperature, humidity, and airflow to promote gradual moisture loss from the eggs. Without being bound by theory, such moisture loss induces aging of the eggs and results in an increase in the internal pH of the eggs, for example to a range of about pH 9 to 10.

As a result of the increased pH and aging, adhesion between an inner eggshell membrane and the egg white is reduced. In particular, the drying process promotes separation between the inner membrane and the albumen, thereby facilitating subsequent removal of the eggshell.

In some embodiments, the drying process improves peeling efficiency and reduces damage to the egg white during shell removal, especially when combined with subsequent controlled cracking and cooking processes as described herein.

In some embodiments, the drying chamber may be maintained at a temperature between about 20 °C and 40 °C and a relative humidity between about 30% and 70%. Airflow may be provided to ensure uniform drying across multiple eggs.

In some embodiments, the drying chamber is maintained at a temperature between about 20 °C and about 40 °C, for example between about 25 °C and about 35 °C, and a relative humidity between about 30% and about 70%, for example between about 40% and about 60%. Airflow may be provided to ensure uniform drying across multiple eggs. The temperature range of about 20 °C to about 40 °C is important to facilitate controlled moisture evaporation and gas exchange within the eggs, thereby promoting an increase in internal pH. If the temperature is below about 20 °C, moisture evaporation and gas exchange may be insufficient, resulting in inadequate increase in internal pH and insufficient reduction of adhesion between the eggshell membrane and egg white. If the temperature exceeds about 40 °C, excessive moisture loss may occur, potentially causing undesirable changes in egg texture, protein denaturation, or degradation of internal structure. The relative humidity range of about 30% to about 70% enables balanced moisture removal. If the relative humidity is above about 70%, moisture removal may be hindered, slowing the aging process and reducing the effectiveness of pH increase. If the relative humidity is below about 30%, excessive dehydration may occur, which may lead to shrinkage of the egg contents, reduced product quality, and inconsistent processing results. In some embodiments, maintaining the temperature between about 25 °C and about 35 °C and the relative humidity between about 40% and about 60% provides improved control over the aging process and results in a more consistent increase in internal pH to about 9 to about 10, thereby enhancing separation between the eggshell membrane and egg white and improving peeling efficiency. The combination of controlled temperature, humidity, and airflow provides a reproducible aging environment that is difficult to achieve under uncontrolled ambient conditions.

In some embodiments, the drying duration of about 4 to 8 hours is selected to achieve a balance between sufficient moisture loss and preservation of egg quality.

Drying for less than about 4 hours may result in insufficient increase in internal pH and inadequate separation between the eggshell membrane and egg white. Conversely, drying for longer than about 8 hours may cause excessive dehydration, leading to deterioration of egg texture and increased susceptibility to damage during subsequent cracking.

At pH values below about 9, adhesion between the inner eggshell membrane and the egg white remains relatively strong. As a result, separation of the membrane from the egg white is incomplete, leading to reduced peeling efficiency and an increased likelihood of tearing or damage to the egg white during shell removal.

At pH values above about 10, excessive protein denaturation may occur within the egg white. Such over-denaturation can adversely affect the structural integrity and texture of the egg, resulting in undesirable softness, fragmentation, or quality degradation during subsequent cracking and cooking processes.

Accordingly, the pH range of about 9 to 10 represents a balance between sufficient reduction in membrane adhesion and preservation of egg structure, thereby improving peeling efficiency while maintaining product quality.

In some embodiments, the rotating paddle assembly 30 may comprise a rotatable shaft 31 and a plurality of spoon-shaped members 32 mounted thereon. Each spoon-shaped member 32 may be configured to receive an egg from the conveying path.

As the rotating paddle assembly rotates, the spoon-shaped members 32 reorient the eggs into a stable position. The geometry of each spoon-shaped member 32 supports the egg and guides the egg along a downward path during rotation. In some embodiments, the method 100 may comprise steps of guiding the egg along the downward path 1051 after receiving the single egg in each spoon-shaped member of a rotating paddle assembly 105.

At a lower portion of the rotating paddle assembly, each spoon-shaped member 32 releases the egg under gravity, allowing the egg to exit the paddle assembly in a controlled manner.

In some embodiments, the plurality of spoon-shaped members 32 are arranged in a spaced-apart manner along the shaft 31, such that adjacent spoon-shaped members are separated by a predetermined distance. Each spoon-shaped member 32 is configured to receive and support a single egg, and the spacing between adjacent spoon-shaped members 32 prevents interference or contact between adjacent eggs during operation.

In some embodiments, the spacing between adjacent spoon-shaped members 32 is selected such that only one egg is received in each spoon-shaped member at a time, thereby ensuring individual handling of eggs. The spaced arrangement of the spoon-shaped members 32 enables eggs to be sequentially received, reoriented, and released in an orderly manner along the rotational path of the paddle assembly. As the rotating paddle assembly 30 rotates, each spoon-shaped member 32 independently carries a corresponding egg along a downward path and releases the egg under gravity at a release position. The spaced configuration further cooperates with the conveying assembly to ensure that eggs are delivered to the rotating paddle assembly one at a time, and that each egg is aligned with a corresponding spoon-shaped member. In some embodiments, the spaced arrangement of the spoon-shaped members 32, in combination with intermittent rotation of the rotating paddle assembly 30, enables sequential release of eggs one at a time, thereby improving consistency of drop timing, impact conditions, and controlled cracking performance. If the spoon-shaped members are not spaced apart or are arranged too closely, multiple eggs may be received simultaneously or may interfere with each other, resulting in misalignment, collision, or inconsistent release timing, which may adversely affect controlled cracking and subsequent processing steps.

In some embodiments, eggs are conveyed along a processing path using a plurality of rollers 21. Partition members 22 are provided to separate adjacent eggs and maintain spacing between the eggs during conveying. The rollers 21 and partition members 22 may cooperate to guide the eggs toward the rotating paddle assembly 30 in a one-by-one orderly manner, ensuring that eggs are delivered individually to corresponding spoon-shaped members 32.

In some embodiments, a metal bar 33 is positioned below the rotating paddle assembly 30 to receive eggs released therefrom. The metal bar 33 may be vertically adjustable relative to the rotating paddle assembly 30 to vary the controlled distance between the release point and the impact surface. By adjusting this controlled distance, the impact force applied to the eggs upon contact with the metal bar 33 can be controlled. This controlled impact induces cracking of the eggshell while minimizing damage to internal egg contents.

In some embodiments, the controlled distance between the rotating paddle assembly 30 and the metal bar 33 is selected to be between about 5 mm and 50 mm. Controlled distances below about 5 mm may result in insufficient impact force, leading to incomplete cracking of the eggshell. Controlled distances above 50 mm may result in excessive impact force, causing fragmentation of the eggshell and potential damage to the egg white. Accordingly, the selected controlled distance range provides controlled cracking of the eggshell without causing fragmentation.

In some embodiments, each spoon-shaped member 32 may be configured to support a single egg. The spacing and geometry of the spoon-shaped 32 members may be arranged such that only one egg is received and retained in each member during operation. This individual support ensures consistent positioning and orientation of each egg and facilitates controlled release and impact during subsequent processing steps.

In some embodiments, the rotating paddle assembly 30 may be configured to rotate intermittently, with pauses between successive rotational movements. During each pause, one or more spoon-shaped members 32 are positioned at a release location, allowing individual eggs to be released under gravity from the rotating paddle assembly. The intermittent rotation enables eggs to be released sequentially, one at a time, rather than simultaneously.

In some embodiments, intermittent rotation of the rotating paddle assembly 30 provides improved control over egg handling and release. If the rotating paddle assembly 30 rotates continuously, multiple eggs may be released in rapid succession or simultaneously, leading to collisions between eggs, inconsistent drop timing, and variability in impact conditions. Therefore, intermittent rotation introduces controlled pauses that allow each egg to be released individually. This improves consistency in drop position and timing, resulting in more uniform impact on the metal bar and more predictable cracking behavior.

In some embodiments, sequential release of eggs enhances the effectiveness of controlled cracking. Releasing eggs one at a time ensures that each egg impacts the metal bar 33 under substantially similar conditions, including drop distance and orientation. This consistency improves reproducibility of crack formation and reduces the likelihood of excessive fragmentation or damage to the egg white.

In some embodiments, the intermittent rotation works in combination with spoon-shaped members 32 configured to support a single egg. The coordinated operation ensures that each egg is individually received, positioned, and released in a controlled sequence. This coordinated control reduces interference between eggs and enhances overall processing efficiency.

In some embodiments, eggs may be pre-selected prior to processing to have a weight variation within a range of about ±2 grams relative to a target weight. Maintaining eggs within this narrow weight variation ensures more uniform heat transfer during subsequent cooking. Eggs of significantly different sizes may experience uneven heating, resulting in inconsistent internal structures, such as overcooking of smaller eggs or undercooking of larger eggs. By limiting the weight variation, heat penetration during boiling is more consistent across multiple eggs, thereby improving uniformity of the soft-boiled interior.

In some embodiments, the weight variation is limited to about ±2 grams to achieve consistent thermal processing. When the weight variation exceeds about ±2 grams, differences in egg size may lead to non-uniform heat distribution during cooking. Smaller eggs may reach a fully cooked state more rapidly, while larger eggs may remain insufficiently cooked, particularly in the yolk region. Conversely, maintaining a narrow weight range improves reproducibility of cooking results, especially when combined with controlled cracking and drying processes as described herein.

In some embodiments, uniform egg size further enhances the effectiveness of controlled cracking and subsequent peeling. Eggs of similar size experience more consistent impact forces when dropped onto the metal bar, thereby promoting uniform crack formation.

In some embodiments, the heating apparatus is configured to heat the eggs at a temperature sufficient to produce a soft-boiled interior.

In some embodiments, the heating temperature is between 70 °C and 90 °C. Heating within this temperature range allows controlled coagulation of egg white while maintaining a soft or semi-liquid yolk. If the temperature is below 70 °C, the egg white may not sufficiently coagulate, resulting in an undesired texture. If the temperature exceeds 90 °C, the egg yolk may become overly solidified, thereby deviating from the desired soft-boiled characteristics. In some embodiments, the heating is performed for a duration sufficient to produce the soft-boiled interior. In some embodiments, the heating duration is between about 10 minutes and about 30 minutes. If the heating duration is too short, the egg white may not sufficiently set. If the heating duration is too long, the egg yolk may become overly firm or fully solidified. In some embodiments, the heating duration is selected in combination with the heating temperature. For example, at a temperature of about 80 °C, the heating duration may be about 20 minutes.

Accordingly, the combination of the temperature range and the duration range enables control of a soft-boiled interior with a partially coagulated egg white and a soft yolk.

In some embodiments, the heating is performed after the eggs have been subjected to a drying process and controlled cracking. The controlled cracking facilitates heat transfer into the eggs, thereby enabling the desired soft-boiled texture to be achieved within the specified temperature and duration ranges.

In some embodiments, the prior drying process and controlled cracking enhance the effectiveness of the boiling step. The drying process increases internal pH and reduces adhesion between the eggshell membrane and egg white, while the controlled cracking introduces microfractures in the eggshell. These conditions facilitate more uniform heat transfer during cooking at about 80 °C, allowing consistent formation of the desired soft-boiled structure across multiple eggs.

In some embodiments, after boiling, the eggs are subjected to a cooling process. In some embodiments, the cooling process comprises a first cooling step 109 in which the eggs are soaked in water to reduce internal temperature, and a second cooling step 1091 in which the eggs are cooled in a cooling tank maintained within a controlled temperature range to stabilize internal structure 1091. The first cooling step 109 provides rapid heat removal, while the second cooling step 1091 provides controlled stabilization of the egg structure. In some embodiments, the eggs may be soaked in cold water for a duration of about 20 to 60 minutes, and in particular about 40 minutes. In some embodiments, the soaking duration is selected to achieve sufficient reduction in internal temperature of the eggs. If the soaking duration is too short, residual heat within the eggs may continue to cook the egg contents, resulting in overcooking and degradation of the desired soft-boiled texture. If the soaking duration is sufficient, the internal temperature of the eggs is reduced to a level that stabilizes the egg white and yolk structure and improves peeling performance.

In some embodiments, the soaking step 109 is performed by immersing the eggs in water at a temperature between 5 °C and 25 °C for a duration between 10 minutes and 60 minutes. The soaking temperature and duration are selected to rapidly remove residual heat from the eggs after heating, thereby preventing continued cooking of the egg contents. If the soaking temperature is above 25 °C, the rate of heat removal may be insufficient, allowing residual heat within the eggs to continue cooking the egg white and yolk, which may result in overcooking and loss of the desired soft-boiled texture. If the soaking temperature is below 5 °C, excessive thermal shock may occur, potentially causing cracking damage, structural stress, or undesirable changes in egg texture. Similarly, if the soaking duration is less than 10 minutes, residual heat may not be sufficiently removed, resulting in inconsistent internal structure. If the soaking duration exceeds 60 minutes, excessive water exposure or overcooling may occur, which may negatively affect product quality and processing efficiency. In some embodiments, soaking is performed at a temperature between 10 °C and 20 °C for a duration between 20 minutes and 40 minutes to achieve improved control of heat removal and more consistent internal structure. The soaking step 109 thus provides a controlled rapid cooling stage, which prepares the eggs for subsequent controlled cooling and stabilization.

In some embodiments, the soaking step 109 is performed at a relatively higher temperature and provides a higher cooling rate to achieve rapid heat removal. In some embodiments, the controlled cooling step 1091 is performed at a lower temperature than the soaking step and provides a lower cooling rate to enable gradual stabilization of the egg white and yolk. If the eggs are directly subjected to controlled cooling without the soaking step, residual heat within the eggs may result in continued cooking and inconsistent internal texture.

Accordingly, the sequential soaking 109 and cooling steps 1091 provide rapid initial cooling followed by controlled stabilization, thereby improving structural integrity, consistency, and peeling performance of the eggs.

In still some embodiments, the cooling tank 60 may comprise a cooling liquid. The cooling tank 60 may be maintained at a temperature above 0 °C and below 1 °C. Maintaining the cooling temperature within this range allows rapid reduction of the internal temperature of the eggs while preventing freezing of the eggs. Rapid cooling stabilizes the internal structure of the egg, including the egg white and yolk, thereby preserving the desired soft-boiled consistency.

In some embodiments, maintaining the cooling temperature above 0 °C is important to prevent freezing of the egg contents. If the temperature falls to or below 0 °C, formation of ice crystals may occur, which can disrupt the structure of the egg white and yolk, leading to undesirable texture changes and potential damage to the egg. Conversely, if the cooling temperature exceeds about 1 °C, the rate of heat removal may be insufficient to rapidly stabilize the egg structure. Slower cooling may result in continued thermal effects, leading to overcooking of the egg interior and reduced control over the final soft-boiled consistency.

Accordingly, maintaining the cooling temperature within a narrow range above 0 °C and below 1 °C provides a balance between rapid cooling and avoidance of freezing, thereby preserving both structural integrity and product quality.

In some embodiments, controlled cooling within the specified temperature range further enhances peeling performance. Rapid stabilization of the egg white reduces adhesion between the egg white and the eggshell membrane following cracking, thereby facilitating removal of the eggshell. Additionally, avoiding freezing ensures that cracks formed during the impact process are not propagated into undesirable fractures that may damage the egg white.

In some embodiments, after cooling, the eggs are treated with ozone-treated water to reduce microbial contamination 110. The ozone-treated water may be generated using an ozone generator and supplied to a treatment tank in which the eggs are immersed or contacted.

In some embodiments, the ozone water treatment is performed while removing the eggshells and/or after the eggshell has been cracked. Cracking the eggshell prior to ozone treatment facilitates penetration of ozone-treated water through microfractures formed in the eggshell. This enhances the contact between the ozone-treated water and the inner surface of the shell and membrane. As a result, microbial contaminants present on or within the eggshell structure can be more effectively reduced compared to treatment applied before cracking.

In some embodiments, if ozone treatment is performed prior to cracking, the intact eggshell may act as a barrier that limits penetration of ozone-treated water. This may reduce sterilization effectiveness, particularly with respect to contaminants located within pores or beneath the shell surface. Accordingly, performing ozone treatment after controlled cracking improves sterilization efficiency.

In some embodiments, ozone treatment after cracking further facilitates subsequent shell removal by reducing microbial load at the interface between the eggshell and egg white. Additionally, reducing microbial contamination at this stage improves the effectiveness of subsequent ultraviolet sterilization and vacuum packaging processes, thereby enhancing overall product safety and shelf life.

In some embodiments, after removal of the eggshell, the eggs may be subjected to a sterilization process using ultraviolet (UV) light 112. The ultraviolet light may be provided by one or more UV lamps positioned to irradiate the surface of the eggs. The UV treatment reduces microbial contamination present on the surface of the eggs prior to packaging. Following UV sterilization, the eggs may be placed in a packaging apparatus 201 and vacuum-packaged 113. The packaging apparatus 201 may include a vacuum chamber configured to remove air from the package prior to sealing. Removal of air reduces the presence of oxygen within the package, thereby inhibiting microbial growth and oxidation processes.

In some embodiments, the vacuum-packaged eggs may be subsequently subjected to a heating process 114. The vacuum heating step 114 further stabilizes the internal structure of the eggs and reduces microbial contamination within the sealed package. Because the eggs are enclosed within a vacuum environment, heat transfer occurs under reduced oxygen conditions, which minimizes oxidation and preserves product quality.

In some embodiments, the combination of UV sterilization, vacuum packaging, and vacuum heating provides a multi-stage microbial reduction process. UV sterilization reduces surface contamination prior to packaging. Vacuum packaging limits exposure to oxygen and external contaminants. Subsequent vacuum heating further reduces microbial load within the sealed environment. This sequential processing provides enhanced sterilization compared to any single treatment alone.

In some embodiments, performing UV sterilization prior to vacuum packaging ensures that surface contaminants are reduced before the eggs are enclosed in a sealed environment. If packaging is performed prior to sterilization, contaminants could be trapped within the package, reducing the effectiveness of subsequent treatments. Accordingly, the sequence of UV sterilization followed by vacuum packaging improves overall sanitation and product safety.

In some embodiments, heating the eggs after vacuum packaging allows microbial reduction to occur within a sealed environment, thereby preventing recontamination. Additionally, vacuum heating stabilizes the egg structure after peeling and handling, reducing variability in texture and extending shelf life.

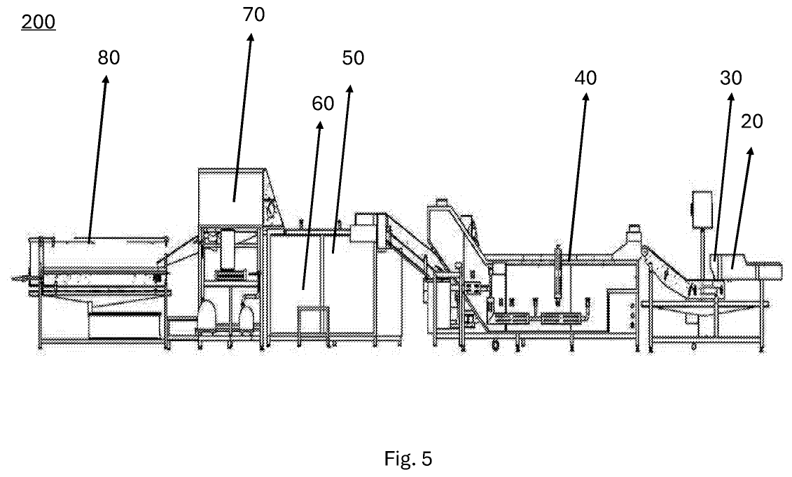

As shown in further details of FIGS. 5-9, the soft-boiled eggs production system 200 may further comprise a conveying assembly 20 comprising a plurality of rollers 21 and partition members 22 configured to transport and separate eggs along a processing path, a rotating paddle assembly 30 comprising a rotatable shaft 31 and a plurality of spoon-shaped members 32 mounted on the shaft, each spoon-shaped member 32 configured to receive and support a single egg, wherein the rotating paddle assembly 30 may be configured such that eggs are released from the spoon-shaped members 32 under gravity at a lower portion of the rotating paddle assembly, a metal bar 33 positioned below the rotating paddle assembly 30 to receive eggs released from the rotating paddle assembly 30; wherein the metal bar 33 is vertically adjustable relative to the rotating paddle assembly 30 to vary a controlled distance therebetween and to control an impact force applied to the eggs to induce controlled cracking of eggshells without causing fragmentation; a heating apparatus/unit 40 configured to cook the eggs to produce a soft-boiled interior; a cooling tank 60 configured to cool the eggs; a treatment station 80 configured to expose the eggs to ozone-treated water and ultraviolet light; and a packaging apparatus 201 configured to vacuum-package and heat the eggs. The heating apparatus 40 may include a heating vessel, water bath, or other suitable thermal processing device configured to maintain a controlled temperature environment for heating the eggs. In some embodiments, the cooling tank 60 may contain a cooling medium, such as water or other suitable fluid, maintained within a controlled temperature range.

In some embodiments, the heating apparatus 40 is configured to maintain a sufficient temperature to partially coagulate egg white while preserving a soft or semi-liquid yolk.

In some embodiments, the system 200 may further include a drying chamber 90 or controlled environment configured to maintain eggs under selected temperature and humidity conditions for a period of time to increase internal pH and promote membrane separation. In some embodiments, the drying chamber 90 may be maintained at a temperature between about 20 °C and 40 °C and a relative humidity between about 30% and 70%. Airflow may be provided to ensure uniform drying across multiple eggs.

In some embodiments, a system 200 may comprise a conveying assembly 20, a rotating paddle assembly 30, a metal bar 33, a heating apparatus 40, a soaking unit 50, a cooling tank 60, a treatment station 80, and a packaging apparatus 201 arranged along a processing path. The system 200 may be configured to process eggs sequentially through positioning, controlled cracking, cooking, cooling, sterilization, and packaging operations.

In some embodiments, the system 200 may comprise a plurality of 21 rollers configured to transport eggs along the processing path. Partition members 22 may be arranged between adjacent eggs to maintain separation and alignment during conveying. The rollers 21 and partition members 22 cooperate to guide eggs toward downstream processing components in an orderly manner.

In some embodiments, the rotating paddle assembly 30 may further comprise a rotatable shaft 31 and a plurality of spoon-shaped members 32 mounted on the shaft 31. Each spoon-shaped member 32 may be configured to receive and support an individual egg. As the paddle rotates, the 32 spoon-shaped members guide the eggs along a downward path and release the eggs under gravity at a lower portion of the assembly.

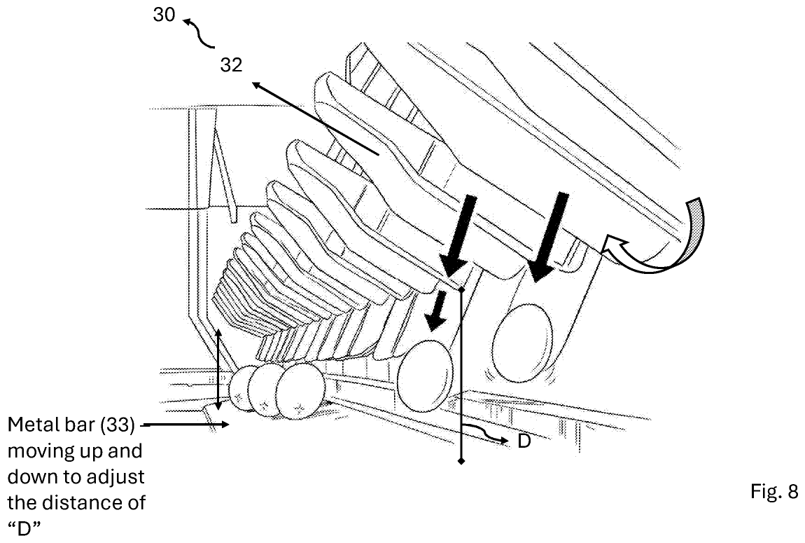

As shown in further details in FIG. 8, in some embodiments, the metal bar 33 may be positioned below the rotating paddle assembly 30 to receive eggs released therefrom. The metal bar 33 may be mounted such that its vertical position relative to the rotating paddle assembly 30 is adjustable. Adjusting the relative position changes the controlled distance “D” between the release point and the metal bar, thereby controlling the impact force applied to the eggs. The impact force is selected to induce controlled cracking of the eggshell without causing fragmentation or damage to internal egg contents.

In some embodiments, the system 200 may comprise a heating apparatus 40 configured to cook the eggs to produce a soft-boiled interior. The heating apparatus 40 may include a heated liquid bath or equivalent structure capable of maintaining a controlled temperature.

In some embodiments, the system 200 comprises a soaking unit 50 configured to receive the eggs after heating and to expose the eggs to water to reduce internal temperature of the eggs.

The soaking unit 50 may include a tank or container containing water in which the eggs are immersed. In some embodiments, the soaking unit 50 may include a flow-through water bath configured to continuously supply cooling water.

In some embodiments, the soaking unit 50 may include a spraying system configured to spray water onto the eggs. In some embodiments, the soaking unit 50 may include a conveyor-based system in which eggs are transported through a region of water flow, spraying, or cascading water.

Accordingly, the soaking unit 50 is not limited to immersion-based configurations and may include any structure capable of exposing the eggs to water to facilitate heat removal.

In some embodiments, the soaking unit 50 may be configured to provide rapid initial cooling of the eggs after heating, thereby removing residual heat and preventing continued cooking of the egg contents.

In some embodiments, the eggs may be retained in the soaking unit 50 for a duration sufficient to reduce internal temperature, for example, between about 20 minutes and about 60 minutes, and in particular about 40 minutes.

In some embodiments, the soaking unit 50 operates prior to the cooling tank 60, wherein the soaking unit 50 provides rapid initial cooling and the cooling tank 60 provides controlled stabilization of the internal structure of the eggs.

In some embodiments, the soaking unit 50 operates at a higher temperature and provides a higher cooling rate to rapidly reduce internal temperature of the eggs. The cooling tank 60 may be configured to subsequently cool the eggs under controlled temperature conditions to stabilize the internal structure of the eggs. In some embodiments, the cooling tank 60 maintains the eggs at a lower temperature than the soaking unit 50 and provides a lower cooling rate to enable gradual stabilization. If the eggs are directly subjected to controlled cooling without the soaking step, residual heat may result in continued cooking and inconsistent internal texture. Accordingly, the soaking unit 50 and the cooling tank 60 perform distinct cooling functions, and their sequential arrangement improves product consistency, structural integrity, and peeling performance.

In some embodiments, the system 200 comprises the soaking unit 50 configured to receive the eggs after heating and the cooling tank 60 configured to receive the eggs from the soaking unit 50. The soaking unit 50 and the cooling tank 60 may arranged sequentially. The eggs may first be subjected to a soaking process in the soaking unit 50 to provide rapid initial cooling and remove residual heat, thereby preventing continued cooking of the egg contents. The eggs may subsequently be transferred to the cooling tank 60, which may be configured to maintain the eggs within a controlled temperature range to stabilize the internal structure of the eggs.

In some embodiments, the cooling tank 60 may contain a cooling liquid maintained at a temperature above 0 °C and below about 1 °C to rapidly stabilize the egg structure while preventing freezing.

In some embodiments, the system 200 may comprise a treatment station 80 configured to expose the eggs to ozone-treated water and ultraviolet (UV) light. The ozone-treated water may be generated by an ozone generator and supplied to a treatment tank. The ultraviolet light may be provided by one or more UV lamps configured to irradiate the eggs. In some embodiments, the treatment station 80 comprises an ozone treatment unit and a UV sterilization unit. The ozone treatment unit is configured to expose the eggs to ozone-treated water to reduce microbial contamination, and the UV sterilization unit is configured to irradiate the eggs with ultraviolet light to further reduce surface microorganisms.

In some embodiments, the system 200 may further comprise a shell removal unit 70 configured to remove eggshells from the eggs. The shell removal unit may be positioned downstream of the cooling tank 60 and is configured to separate the eggshell from the egg contents after the eggshell has been weakened by the cracking and cooling processes. In some embodiments, ozone treatment may be applied during the shell removal process. The eggs may be exposed to ozone-treated water while the eggshell is being removed.

The prior cracking step creates microfractures in the eggshell, and the shell removal process further exposes internal surfaces. The application of ozone during this stage enhances penetration of ozone through the eggshell and into exposed regions, thereby improving microbial reduction efficiency.

Accordingly, the combination of shell removal and ozone treatment provides enhanced antimicrobial performance compared to ozone treatment applied prior to shell removal.

In some embodiments, the system 200 may comprise the packaging apparatus 201 configured to vacuum-package the eggs. The packaging apparatus 201 may include a vacuum chamber configured to remove air prior to sealing. The system 200 may further comprise a heater configured to heat the vacuum-packaged eggs.

In some embodiments, the controlled distance between the rotating paddle assembly 30 and the metal bar 33 may be between 5 mm and 50 mm. Controlled distances below 5 mm may result in insufficient cracking, while controlled distances above 50 mm may result in excessive impact and fragmentation.

In some embodiments, the rotating paddle assembly 30 may be configured to rotate intermittently with pauses between rotations. The pauses allow eggs to be released sequentially, one at a time, thereby improving consistency of drop timing and impact conditions.

In some embodiments, the system 200 may further comprise the drying chamber 90 configured to maintain eggs under controlled environmental conditions for a duration of about 4 to 8 hours. The drying chamber 90 may control temperature, humidity, and airflow to promote moisture loss, resulting in an increase in internal pH to about 9 to 10 and promoting separation between the eggshell membrane and egg white.

In some embodiments, each spoon-shaped member 32 may be sized and spaced to support a single egg. This configuration ensures consistent positioning and prevents interference between eggs during processing.

In some embodiments, the cooling tank 60 may be maintained above 0 °C to prevent freezing and below 1 °C to ensure rapid cooling. This temperature range stabilizes the internal structure of the eggs without causing ice formation.

In some embodiments, the packaging apparatus 201 may comprise a heater configured to heat vacuum-packaged eggs at a temperature of 60-90 °C. This temperature range reduces microbial contamination while maintaining the desired texture of the eggs. In some embodiments, the vacuum-heating step is important for stabilizing the internal structure of the eggs while maintaining a desired soft-boiled texture. Without the vacuum-heating step, residual moisture and heat within the eggs may result in structural instability, leading to deformation or inconsistency of the egg white and yolk during subsequent handling or storage. The vacuum-heating process also contributes to microbial reduction. By heating the eggs under controlled temperature conditions, microorganisms may be inactivated while avoiding excessive heat exposure that would otherwise overcook the eggs. In addition, the vacuum environment reduces oxygen exposure and improves heat transfer uniformity, thereby enabling more consistent thermal treatment throughout the eggs. Accordingly, the vacuum-heating step enhances product consistency, structural integrity, and shelf life of the eggs, while preserving the desired soft-boiled characteristics.

In some embodiments, the temperature range of the vacuum-heating process is important for achieving a balance between structural stabilization and microbial reduction while maintaining the desired soft-boiled characteristics of the eggs. If the temperature is too low, microbial inactivation may be insufficient, and the internal structure of the eggs may remain unstable, leading to deformation or reduced shelf life. If the temperature is too high, excessive heat may cause further coagulation of the egg white and yolk, resulting in overcooking and loss of the desired soft-boiled texture. Accordingly, a temperature range between about 60 °C and about 90 °C provides an effective balance, enabling sufficient microbial reduction and structural stabilization without adversely affecting the internal texture of the eggs. In particular, a temperature range of about 70 °C to about 80 °C may provide improved consistency in achieving the desired soft-boiled state.

In some embodiments, eggs may be placed in the drying chamber 90 under controlled environmental conditions for a duration of about 4-8 hours. During this process, the internal pH of the eggs increases to about 9-10, which promotes separation between the eggshell membrane and egg white and facilitates subsequent peeling.

In some embodiments, the rotating paddle assembly 30 may comprise the rotatable shaft 31 and a plurality of spoon-shaped members 32, each configured to receive and support a single egg. As the paddle rotates, each egg is guided along a downward path and released under gravity at a lower portion of the assembly 30. Eggs released from the rotating paddle assembly 30 fall under gravity and impact the metal bar 33 positioned below the assembly. The metal bar 33 induces controlled cracking of the eggshell without causing fragmentation or damage to internal contents.

In some embodiments, the metal bar 33 may be vertically adjustable relative to the rotating paddle assembly 30 to vary the drop distance. In some embodiments, the controlled distance may be between about 5 mm and 50 mm, which provides sufficient impact force to crack the eggshell while maintaining internal integrity. Eggs are cooked in the heating apparatus 40 maintained at about 80 °C for approximately 20 minutes to produce a soft-boiled interior. The eggs are then cooled in the cooling tank 60 maintained above 0 °C and below 1 °C to stabilize internal structure without freezing.

After cooling, eggs may be treated with ozone-treated water to reduce microbial contamination. The eggs may further be exposed to ultraviolet (UV) light for sterilization. The eggs are then vacuum-packaged in the packaging apparatus 201 including a vacuum chamber and sealing device and may be heated at about 70-80 °C to further stabilize the product.

Similarly, while operations and/or methods may be depicted in the drawings in a particular order, this should not be understood as requiring that such operations be performed in the particular order shown or in sequential order, or that all illustrated operations and/or method steps be performed, to achieve desirable results. In certain circumstances, multitasking and parallel processing may be advantageous.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more, or different elements, which are disclosed herein even when not initially claimed in such combinations.

Thus, specific embodiments and applications of a system and method for producing soft-boiled eggs have been disclosed. It should be apparent, however, to those skilled in the art that many more modifications besides those already described are possible without departing from the disclosed concepts herein. Therefore, the disclosed embodiments are not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be substituted, and what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

The words used in this specification to describe the various embodiments are to be understood not only in the sense of their commonly defined meanings, but also to include, by special definition in this specification, structure, material, or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in the same way to obtain the same result. In this sense it is therefore contemplated that an equivalent substitution of two or more elements may be made for any one of the elements in the claims below, or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

What is claimed is:

1. A method of producing soft-boiled eggs by a soft-boiled eggs production system, comprising:
subjecting eggs to a drying chamber to induce aging and increase an internal pH of the eggs, thereby reducing adhesion between an eggshell membrane and egg white;
conveying the eggs by a conveying assembly to a rotating paddle assembly;
reorienting an individual egg into a spoon-shaped member of the rotating paddle assembly and sequentially releasing the individual egg from the spoon-shaped member such that the eggs drop one at a time under gravity;
allowing the eggs to drop under gravity onto a metal bar from a controlled distance to induce controlled cracking of the eggshell without causing fragmentation;
boiling the eggs after the controlled cracking step under conditions sufficient to produce a soft-boiled interior;
cooling the eggs in a cooling tank after boiling to stabilize the eggs for facilitating removal of the eggshells;
applying ozone to the eggs during removing eggshells from the cooled eggs to reduce microbial contamination; and
treating the eggs with ozone after the removal of eggshells to further reduce microbial contamination of exposed egg surface by the removal of the eggshells; wherein
the increased internal pH facilitates removal of the eggshell after the controlled cracking, and the sequential releasing and the controlled distance cooperate to control an impact force applied to each egg.

2. The method of claim 1, wherein the rotating paddle assembly comprises a rotatable shaft and the plurality of spoon-shaped members rotatably mounted on the rotatable shaft and each of the plurality of spoon-shaped members is spaced apart at a distance sufficient to ensure that only one egg is received in each spoon-shaped member and to enable sequential guiding of the eggs along a downward path and release of eggs to drop under gravity without collision between adjacent eggs.

3. The method of claim 1, further comprising:
sterilizing the eggs using ultraviolet (UV) light after treating the eggs and prior to packaging;
vacuum-packaging the eggs; and
vacuum-heating the vacuum-packaged eggs to further stabilize the eggs and reduce microbial contamination.

4. The method of claim 1, wherein cooling the eggs comprises:
soaking the eggs in water to rapidly reduce an internal temperature of the eggs to remove residual heat and prevent continued cooking of the eggs; and
subsequently cooling the eggs in a cooling tank maintained at a lower temperature than the soaking step to gradually stabilize internal structure of the eggs,
wherein the soaking step provides a higher cooling rate than the cooling tank and the cooling tank provides controlled stabilization to maintain structural integrity of the eggs.

5. The method of claim 1, wherein conveying the eggs comprises using partition members and rollers of the conveying assembly to guide the eggs toward the rotating paddle assembly.

6. The method of claim 1, wherein the metal bar is vertically adjustable to vary the controlled distance between the rotating paddle assembly and the metal bar, and the cracking of the eggshell is controlled by adjusting the controlled distance between the rotating paddle assembly and the metal bar to vary the impact force applied to the eggs.

7. The method of claim 1, wherein the controlled distance between the rotating paddle assembly and the metal bar is between 5 mm and 50 mm to achieve controlled cracking of the eggshell without causing fragmentation.

8. The method of claim 1, wherein each egg is individually supported and positioned by a corresponding spoon-shaped member of the rotating paddle assembly.

9. The method of claim 1, wherein the cooling tank is maintained at a temperature above 0 °C and below 1 °C to prevent freezing of the eggs.

10. The method of claim 1, wherein the eggs are pre-selected to have a weight variation within ±2 grams to promote uniform heat transfer during cooking.

11. The method of claim 1, wherein boiling the eggs comprises heating the eggs at a temperature of 70 °C to 90 °C for a duration sufficient to produce the soft-boiled interior, the duration being between 10 minutes and 30 minutes, the eggs having been previously subjected to the drying process and controlled cracking.

12. The method of claim 1, wherein the rotating paddle assembly comprises a rotatable shaft and the plurality of spoon-shaped members rotatably mounted on the rotatable shaft, and each one of the plurality of spoon-shaped members is intermittently rotated with pauses between rotations to allow individual eggs to be released one at a time.

13. The method of claim 1, wherein the internal pH of the eggs is increased to between 9 and 10 to facilitate removal of the eggshell.

14. The method of claim 3, wherein vacuum-heating the vacuum-packaged eggs comprises heating the eggs at a temperature of 60-90 °C to stabilize internal structure while reducing microbial contamination without overcooking the eggs.

15. A soft-boiled egg production system configured to perform the method of claim 1, the system comprising:
the conveying assembly configured to transport eggs to the rotating paddle assembly;
the rotating paddle assembly configured to receive, reorient, and sequentially release individual eggs;
the metal bar positioned to receive eggs dropped from the rotating paddle assembly and to induce cracking;
a heating apparatus configured to boil the eggs to produce the soft-boiled interior;
a soaking unit configured to receive the eggs after the heating apparatus and to expose the eggs to water to reduce internal temperature;
the cooling tank configured to cool the eggs to stabilize the internal structure;
a treatment station configured to expose the eggs to ozone-treated water and ultraviolet light; and
a packaging apparatus configured to vacuum-package and heat the eggs.

16. The system of claim 15, wherein the metal bar is vertically adjustable relative to the rotating paddle assembly to vary the controlled distance therebetween and to control an impact force applied to the eggs to induce controlled cracking of eggshells, wherein the controlled distance between the rotating paddle assembly and the metal bar is between 5 mm and 50 mm.

17. The system of claim 15, wherein the rotating paddle assembly is configured to intermittently rotate to release eggs one at a time and the conveying assembly comprises a plurality of rollers and partition members configured to transport and separate eggs to the rotating paddle assembly.

18. The system of claim 15, further comprising a drying chamber configured to increase internal pH of the eggs and reduce adhesion between the eggshell membrane and egg white, wherein the internal pH is 9-10.

19. The system of claim 15, wherein the cooling tank is configured to maintain a temperature above 0 °C and below 1 °C.

20. The system of claim 15, wherein the packaging apparatus includes a vacuum chamber and a heater configured to heat vacuum-packaged eggs at a temperature of 60-90 °C.
